(19) United States
(12) Patent Application Publication
(10) Pub. No.: US 2026/0200405 A1
(43) Pub. Date: Jul. 16, 2026

(54) MOUNT BRACKET FOR A RUNNING BOARD OF A VEHICLE

(71) Applicants: William Daniel Davis, Sutherland, VA (US); Brian Driskell Davis, South Chesterfield, VA (US)

(72) Inventors: William Daniel Davis, Sutherland, VA (US); Brian Driskell Davis, South Chesterfield, VA (US)

(73) Assignee: DOR Customs LLC, North Chesterfield, VA (US)

(21) Appl. No.: 19/022,205

(22) Filed: Jan. 15, 2025

(51) Int. Cl. B60R 3/02; B60K 15/063; B60R 3/00; B62D 21/03; B62D 65/16

(52) U.S. Cl. CPC B60R 3/02; B60R 3/002; B62D 65/16; B60K 15/063; B60K 2015/0634; B62D 21/03

(57) ABSTRACT

A mount bracket for mounting a running board assembly to a vehicle may include a main plate that may be securable to a rocker panel. The main plate may extend between a top edge and a bottom edge along a vertical direction, a front edge and a rear edge along a lateral direction, and an inner face and an outer face along a transverse direction. The mount bracket may include a support plate that may be securable to a floorboard. The support plate may extend from the front edge of the main plate along the transverse direction. The mount bracket may include a support member that may be securable to the floorboard. The support member may extend from the inner face of the main plate along the transverse direction. The running board assembly may be securable to the mount bracket at the main plate.

### FIELD OF THE DISCLOSURE

The present subject matter relates generally to a running board of a vehicle and more particularly to systems and methods for mounting a running board to a vehicle.

### BACKGROUND OF THE DISCLOSURE

Vehicles (e.g., cars, trucks, sports utility vehicles, or the like) are used generally for the transport of people and goods, efficiently, safely and comfortably. Many vehicles with higher ground clearances (e.g., trucks or sports utility vehicles) can include running boards that aid entry into and out of the vehicle. For example, the running boards can be mounted under one or more doors of the vehicle to provide a location for a user to step into and out of the vehicle.

In many cases, the running boards can be retractable relative to the body of the vehicle. For example, the running boards can be moved between a deployed position and a retracted position. Such retractable running boards can aid entry into and out of the vehicle in the deployed position and stow away underneath the vehicle (e.g., for increased aerodynamics, improved cosmetics, etc.) in the retracted position. However, while running boards can be mounted or installed on many vehicles and provide the desired performance characteristics, improvements in installing and/or mounting running boards to additional existing vehicles are desired. For example, robust and effective mounting designs are desired to provide improved installation of the running board while reducing cost associated with installation. However, the retractability of the running board and the cosmetics must desirably be maintained.

Accordingly, systems and methods for mounting a running board to a vehicle would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a vehicle is provided. The vehicle may include a frame. The vehicle may include a body mounted to the frame. The body may include a rocker panel and a floorboard. The vehicle may include a mount bracket. The mount bracket may include a main plate that may be secured to the rocker panel. The main plate may extend between a top edge and a bottom edge along a first direction, a front edge and a rear edge along a second direction, and an inner face and an outer face along a third direction. The mount bracket may include a support plate that may be secured to the floorboard. The support plate may extend from the front edge of the main plate along the third direction. The mount bracket may include a support member that may be secured to the floorboard. The support member may extend from the inner face of the main plate along the third direction. The running board assembly may be secured to the mount bracket at the main plate.

In another exemplary aspect of the present disclosure, a mount bracket for mounting a running board assembly to a vehicle is provided. The vehicle may include a frame and a body mounted to the frame. The body may include a rocker panel and a floorboard. The mount bracket may define a vertical direction, a lateral direction, and a transverse direction. The mount bracket may include a main plate that may be securable to the rocker panel. The main plate may extend between a top edge and a bottom edge along the vertical direction, a front edge and a rear edge along the lateral direction, and an inner face and an outer face along the transverse direction. The mount bracket may include a support plate that may be securable to the floorboard. The support plate may extend from the front edge of the main plate along the transverse direction. The mount bracket may include a support member that may be securable to the floorboard. The support member may extend from the inner face of the main plate along the transverse direction. The running board assembly may be securable to the mount bracket at the main plate.

In yet another exemplary aspect of the present disclosure, a method for mounting a running board assembly to a vehicle is provided. The method may include aligning a mount bracket with a body of the vehicle. The method may include securing the mount bracket to the body of the vehicle. The method may include securing the running board assembly to the mount bracket. The method may include coupling the running board assembly to a step control module associate with the running board assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of a vehicle according to one or more exemplary embodiments of the present subject matter.

FIG. 2 provides a perspective view of a body of the vehicle of FIG. 1 according to one or more exemplary embodiments of the present subject matter.

FIG. 3 provides a perspective view of the body of the vehicle of FIG. 1 according to one or more exemplary embodiments of the present subject matter

FIG. 4 provides a perspective view of a running board assembly mounted to the body of the vehicle of FIG. 1 according to one or more exemplary embodiments of the present subject matter.

FIG. 5 provides a perspective view of a mount bracket according to one or more exemplary embodiments of the present subject matter.

FIG. 6 provides a front view of the mount bracket of FIG. 5 according to one or more exemplary embodiments of the present subject matter.

FIG. 7 provides a rear view of the mount bracket of FIG. 5 according to one or more exemplary embodiments of the present subject matter.

FIG. 8 provides a right-side view of the mount bracket of FIG. 5 according to one or more exemplary embodiments of the present subject matter.

FIG. 9 provides a left-side view of the mount bracket of FIG. 5 according to one or more exemplary embodiments of the present subject matter.

FIG. 10 provides a top view of the mount bracket of FIG. 5 according to one or more exemplary embodiments of the present subject matter.

FIG. 11 provides a bottom view of the mount bracket of FIG. 5 according to one or more exemplary embodiments of the present subject matter.

FIG. 12 provides an exploded view of the mount bracket of FIG. 5 according to one or more exemplary embodiments of the present subject matter.

FIG. 13 provides a perspective view of the mount bracket of FIG. 5 mounted to a body of a vehicle according to one or more exemplary aspects of the present subject matter.

FIG. 14 provides a flow chart illustrating a method of mounting a running board assembly to a vehicle according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

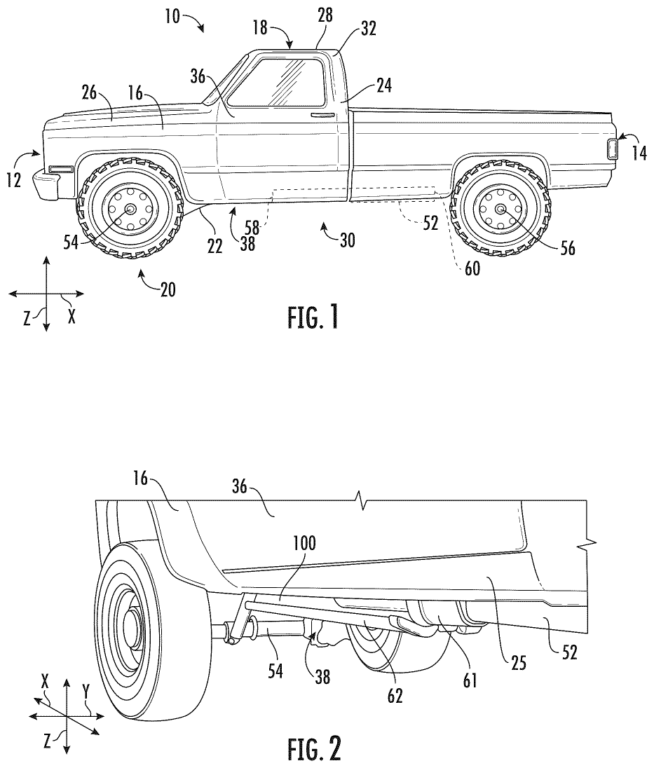

Referring now to the figures, FIGS. 1 through 3 provide views of a vehicle 10 (e.g., a single cab truck). The vehicle 10 may generally extend between a front 12 and a rear 14 along a first direction X (e.g., a direction parallel to a X-axis of the vehicle 10), between a first side 16 (e.g., a driver side) and a second side (e.g., a passenger side) along a second direction Y (e.g., a direction parallel to a Y-axis of the vehicle 10), and a top 18 and a bottom 20 along a third direction Z (e.g., a direction parallel to a Z-axis of the vehicle 10).

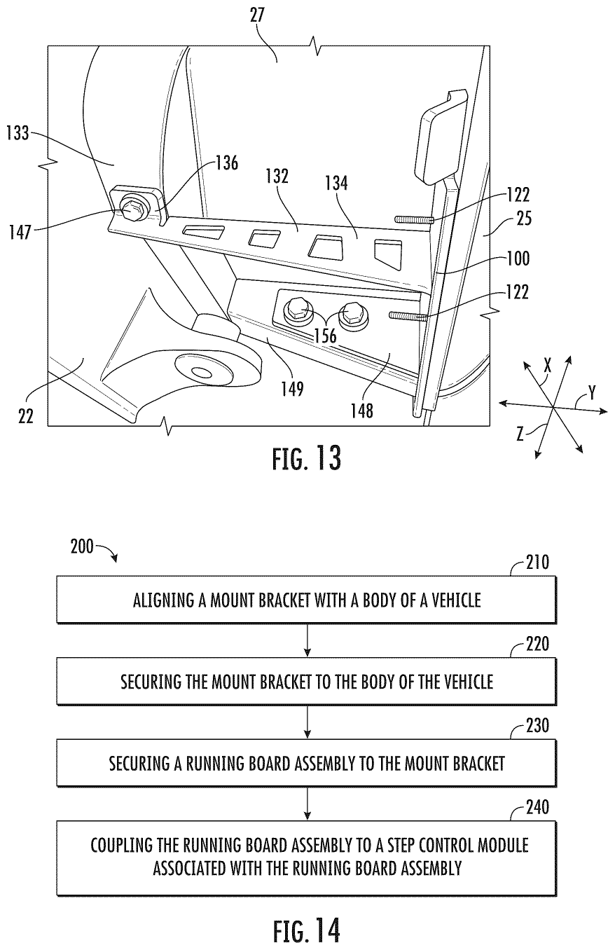

The vehicle 10 may include a frame 22 and a body 24 that may be mounted to the frame 22. The body 24 may include a front end 26 positioned at the front 12 of the vehicle 10. The front end 26 may house a motor (e.g., an engine) of the vehicle 10. The body 24 may include a top side 28 and a bottom side 30 spaced apart along the third direction Z of the vehicle 10. The body 24 may include a cabin 32 extended (e.g., rearward along the first direction X) from the front end 26 of the truck. The body 24, and more particularly, the cabin 32 may include a pair of rocker panels 25 (e.g., a first rocker panel at the first side of the body and a second rocker panel at the second side of the body) and a floorboard 27 (e.g., FIG. 13) extended between the rocker panels 25.

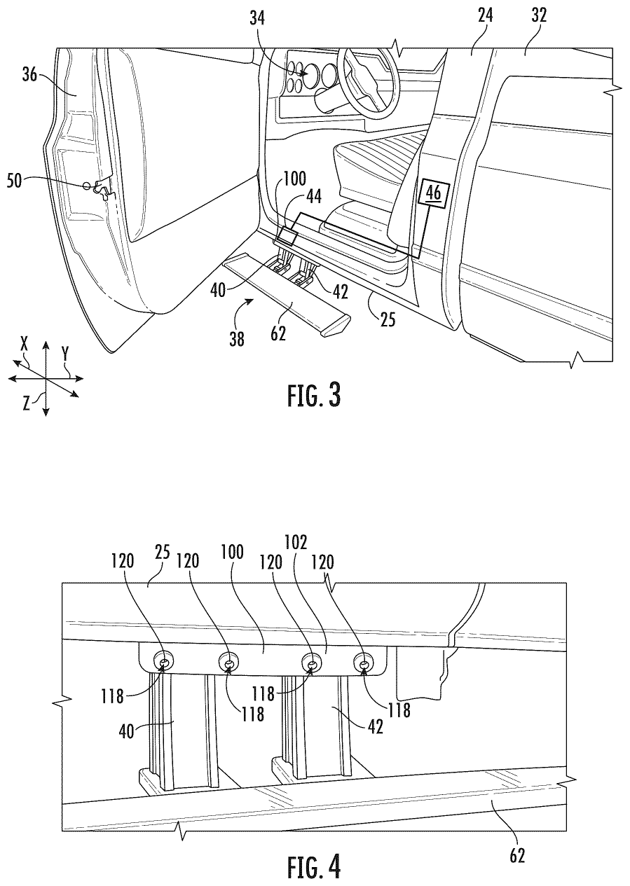

The cabin 32 may define a passenger compartment 34 for housing one or more passengers of the vehicle 10. The body 24 may include doors 36 that may be rotatably mounted to the cabin 32. For example, the doors 36 may be rotatable between an open position (e.g., FIG. 3) wherein access to the passenger compartment 34 is permitted and a closed position (e.g., FIGS. 1 and 2) wherein access to the passenger compartment 34 is restricted.

One of ordinary skill in the art would understand that while described in the context of specific exemplary embodiments of the vehicle 10 (e.g., the single cab truck) the present subject matter disclosed herein may be applicable to any suitable style, or configuration of vehicle 10. For example, the present subject matter may also be applicable to any other suitable truck (e.g., crew cab trucks, double cab trucks, or the like), sports utility vehicles, cars, or the like. Accordingly, the vehicle 10 illustrated in FIGS. 1 through 3 may be provided by way of example only.

The vehicle 10 may include one or more running board assemblies 38 (e.g., a driver side running board assembly and a passenger side running board assembly) that may aid entry and exit of the vehicle 10. For example, the running board assemblies 38 may aid a user in entering and exiting the passenger compartment 34 of the vehicle 10. The running board assemblies 38 may be mounted (e.g., indirectly via a mount bracket 100 described in more detail below) to the body 24 of the vehicle 10. In some embodiments, the running board assemblies 38 are movable between a deployed position and a retracted position. In the deployed position, at least a portion of the running board assembly 38 may be extended from the body 24 of the vehicle 10, for instance, to provide a location (e.g., a step) for the user to utilize in entering or exiting the passenger compartment 34. In the retracted position, the running board assembly 38 may be folded up or tucked away against the body 24 of the vehicle 10.

Notably, the running board assembly 38 may be moved to the retracted position to provide improved ground clearance, aerodynamics, and appearance. As such, the exemplary running board assemblies 38 may generally be configured as retractable running board assemblies 38. It is recognized, however, that the benefits of the present disclosure apply to other types and styles of running board assemblies 38, such as stationary running boards.

The running board assemblies 38 may each include a pair of linkage arms that may be actuated to move a step 62 of the running board assemblies 38 between the deployed position and the retracted position. In particular, the pair of linkage arms may include a first linkage arm 40 and a second linkage arm 42. The first linkage arm 40 and/or the second linkage arm 42 may be coupled to a motor 44 (e.g., an electric motor, such as a DC electric motor, a geared motor, a brushless motor, and/or a brushed motor) configured for actuating a position of the first linkage arm 40 and/or the second linkage arm 42. The vehicle 10 may include a step control module 46 in communication with the motor 44. In this regard, the step control module 46 may instruct or direct operation of the motor 44, for instance, to move the step 62 of the running board assembly 38 between the deployed position and the retracted position. In some embodiments, the step control module 46 is provided as or integral to a vehicle control module, such as a vehicle control unit (e.g., an electronic device that manages a vehicles systems and subsystems). In some other embodiments, the step control module 46 is a stand-alone controller that is separate from the vehicle control module. For instance, the step control module 46 may function separate from the vehicle control unit. The step control module 46 may be programmed with executable instructions for interfacing with and operating the various components of the vehicle 10, such as the motor 44 of the retractable running board assembly 38. The step control module 46 may additionally include a processing unit and non-transitory memory for executing the various control strategies and modes of the vehicle 10 system.

In some embodiments, the step control module 46 is operably coupled to a door position sensor 50 of the vehicle 10. The door position sensor 50 may be configured for detecting a position of the door 36. For example, the door position sensor 50 may include or be provided as a pin switch, an angular position sensor, or the like, that may be coupled (e.g., directly or indirectly) to the door 36 and configured for detecting the position of the door 36. As such, the step control module 46 may receive information indicative to the position of the door 36 from the door position sensor 50. The step control module 46 may utilize information indicative of the position of the door 36 to selectively direct the motor 44 to move the running board assembly 38 (e.g., based on the position of the door 36 relative to the body 24). For example, when the door 36 of the vehicle 10 is moved from the closed position to the open position, the step control module 46 may be configured to direct the motor 44 to move the running board assembly 38 to the deployed position. As another example, when the door 36 of the vehicle 10 is moved from the open position to the closed position, the step control module 46 may be configured to direct the motor 44 to move the running board assembly 38 to the retracted position.

The vehicle 10 may include one or more side saddle gas tanks 52 (e.g., a driver-side side saddle gas tank and a passenger-side side saddle gas tank) mounted to the frame 22 of the vehicle 10. For example, the frame 22 may include a pair of outer rails that extend generally along the first direction X. The side saddle gas tanks 52 may be mounted to an outer surface of the outer rails of the frame 22. The side saddle gas tanks 52 may be positioned between a front axle 54 and a rear axle 56 of the frame 22.

As should be appreciated, side saddle gas tanks, such as side saddle gas tanks 52, are installed on many existing vehicles. For example, vehicles such as the 1973-1986 Chevrolet K10, 1973-1986 General Motors Truck Company (GMC) K10, 1973-1986 Chevrolet C10, 1973-1986 GMC C10, 1987 Chevrolet V10, 1987 GMC V10, 1987 Chevrolet R10, 1987 GMC R10, 1973-1986 Chevrolet K20, 1973-1986 GMC K20, 1973-1986 Chevrolet C20, 1973-1986 GMC C20, 1987 Chevrolet V20, 1987 GMC V20, 1987 Chevrolet R20, 1987 GMC R20, 1973-1987 Chevrolet K30 regular cab truck, 1973-1987 Chevrolet K30 crew cab truck, 1973-1987 GMC K30 regular cab truck, 1973-1987 GMC K30 crew cab truck, 1973-1987 Chevrolet regular cab truck, 1973-1987 Chevrolet crew cab truck, 1973-1987 GMC C30 regular cab truck, 1973-1987 GMC C30 crew cab truck, 1988-1991 Chevrolet V30 regular cab truck, 1988-1991 Chevrolet V30 crew cab truck, 1988-1991 GMC V30 regular cab truck, 1988-1991 GMC V30 crew cab truck, 1988-1991 Chevrolet R30 regular cab truck, 1988-1991 Chevrolet R30 crew cab truck, 1988-1991 GMC R30 regular cab truck, 1988-1991 GMC R30 crew cab truck, or any other suitable make and/or model of vehicle may include a side saddle gas tank.

As illustrated in FIG. 1, the one or more side saddle gas tanks 52 may extend from a front side 58 to a rear side 60. The front side 58 may be positioned rearward of the front axle 54, for instance, at least partially below the door 36 of the vehicle 10, and the rear side 60 may be positioned in front of a rear axle 56 of the frame 22. In some embodiments (e.g., as illustrated in FIG. 2), a bracket or strap 61 may be positioned approximately below the door 36 and may be utilized in securing or mounting the side saddle gas tank 52 to the frame 22. Notably, a step 62 of the running board assembly 38 may be positioned in front of the bracket or strap 61. In this regard, the running board assembly 38 may be positioned below at least a portion of the side saddle gas tank 52, for instance, in front of the bracket or strap 61.

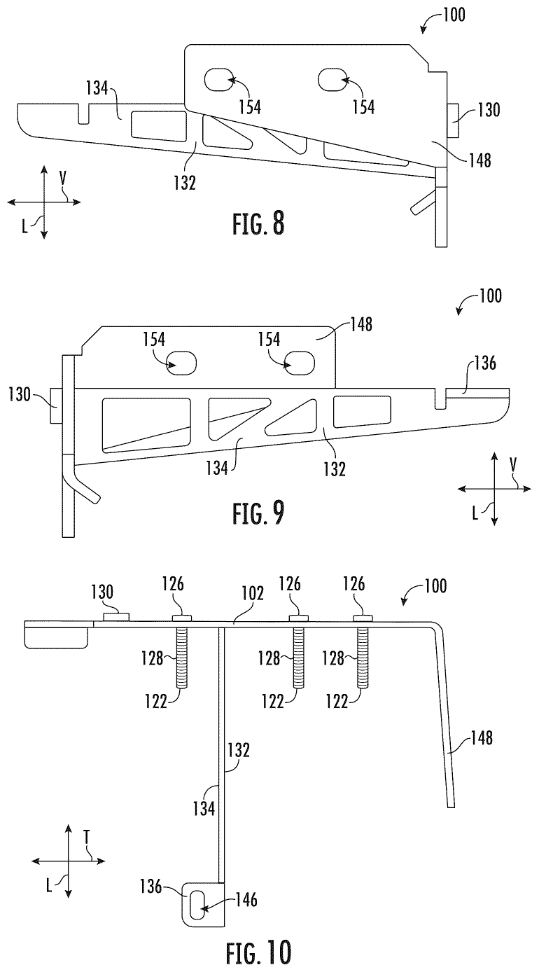

Referring now to FIGS. 4 through 13, embodiments of a mount bracket 100 (e.g., a driver side mount bracket) are provided. As should be appreciated, only a singular mount bracket 100 is illustrated and described herein for the sake of brevity and clarity only. One of ordinary skill in the art would understand that the vehicle 10 may include a discrete mount bracket 100 at the driver side and/or the passenger side of the body 24. In addition, one of ordinary skill in the art would recognize that the structure, configuration, or function of the mount bracket 100 (e.g., the driver side mount bracket 100) illustrated and described below may be mirrored or identical to the structure, configuration, or function of a mount bracket mounted to the passenger side of the vehicle 10.

The mount bracket 100 may be utilized in mounting or installing the running board assembly 38 to the body 24. In some embodiments, each running board assembly 38 may be mounted to the body 24 of the vehicle 10 with a single mount bracket 100. The first linkage arm 40 and the second linkage arm 42 may each be mounted to the mount bracket 100. Notably, the mount bracket 100 advantageously permits installation of the running board assembly 38 on a vehicle 10 that includes a side saddle gas tank 52. For example, when compared to existing running board assemblies that require the removal or relocation of side saddle gas tanks, such as side saddle gas tank 52, for installation. In this regard, the exemplary mount bracket 100 advantageously reduces or mitigates the cost of installing a running board assembly 38 on vehicles that include a side saddle gas tank (e.g., as the cost of removing, replacing, or relocating, one or more gas tanks, such as the side saddle gas tanks 52, of the vehicle 10 is removed).

The mount bracket 100 may define a vertical direction V, a lateral direction L, and a transverse direction T. Together the vertical direction V, the lateral direction L, and the transverse direction T may define an orthogonal coordinate system. In some embodiments, the orthogonal coordinate system of the mount bracket 100 may align with the coordinate system defined by the vehicle 10. For instance, the vertical direction V may align with or extend parallel to the third direction Z of the vehicle 10, the lateral direction L may align with or extend parallel to the first direction X of the vehicle 10, and the transverse direction T may align with or extend parallel to the second direction Y of the vehicle 10.

The mount bracket 100 may include a main plate 102 may be securable to the body 24, and more particularly to the rocker panel 25 of the body 24. For instance, in some embodiments, the main plate 102 is secured to (e.g., fastened to) the body 24, and more particularly to the rocker panel 25 of the body. The main plate 102 may extend between a top edge 104 and a bottom edge 106, for instance, along the vertical direction V. The main plate 102 may extend between a front edge 108 and a rear edge 110, for instance, along the lateral direction L. The main plate 102 may extend between an outer face 112 and an inner face 114, for instance, along the transverse direction T. The main plate 102 may define one or more body holes 116 therethrough. The location of the one or more body holes 116 may correspond to one or more fastener holes defined through the rocker panel 25. In this regard, one or more mechanical fasteners (e.g., a bolt, screw, rivet, or the like) may be disposed through each body hole 116 and the corresponding fastener hole defined through the rocker panel 25 to secure the main plate 102 to the rocker panel 25.

In addition, the main plate 102 may define one or more step holes 118. In some embodiments, the one or more step holes 118 are positioned proximate the bottom edge 106 of the main plate 102. As used herein “proximate the bottom edge 106 of the main plate 102” may refer to the one or more step holes 118 being positioned closer to the bottom edge 106 of the main plate 102 than to the top edge 104 of the main plate 102. For example, the one or more step holes 118 may be positioned within a bottom fifty percent (50%) of the vertical height of the main plate 102. In some embodiments (e.g., as illustrated in FIG. 4), the one or more step holes 118 are be disposed below the rocker panel 25. In this regard, the position of the one or more step holes 118 may correspond to a position of one or more fastener holes defined through the running board assembly 38, and more particularly, through the first linkage arm 40 and/or the second linkage arm 42 of the running board assembly 38. For example, as illustrated in FIG. 4, one or more mechanical fasteners 120, such as one or more bolts, screws, rivets, or the like, may be disposed through each step hole 118 and the corresponding fastener hole defined through the first linkage arm 40 and/or the second linkage arm 42 of the running board assembly 38 to secure the running board assembly 38 to the main plate 102.

The mount bracket 100 may include a plurality of studs 122 for mounting the running board assembly 38 to the mount bracket 100. The plurality of studs 122 may extend through the main plate 102. For example, the main plate 102 may define a plurality of stud holes 124 therethrough. The plurality of stud holes 124 may be spaced apart along the lateral direction L and positioned proximate the top edge 104 of the main plate 102. As used herein “proximate the top edge 104 of the main plate 102” may refer to the plurality of stud holes 124 being positioned closer to the top edge 104 of the main plate 102 than to the bottom edge 106 of the main plate 102. For example, the plurality of stud holes 124 may be positioned within a top fifty percent (50%) of the vertical height of the main plate 102. The plurality of studs 122 may be received through the plurality stud holes 124 and secured to the main plate 102. For instance, each stud of the plurality of studs 122 may include a head 126 that is engaged with the outer face 112 of the main plate 102. The head 126 may be joined (e.g., welded or secured in any other suitable manner) to the outer face 112 of the main plate 102 to secure the plurality of studs 122 to the main plate 102. In some embodiments, each stud of the plurality of studs 122 includes a threaded portion 128 for receiving a locking fastener (e.g., a locking nut, such as a nylon insert locknut, a jam nut, a castle nut, or the like) configured for threading onto the threaded portion 128 of the stud and securing the retractable running board assembly 38 to the mount bracket 100.

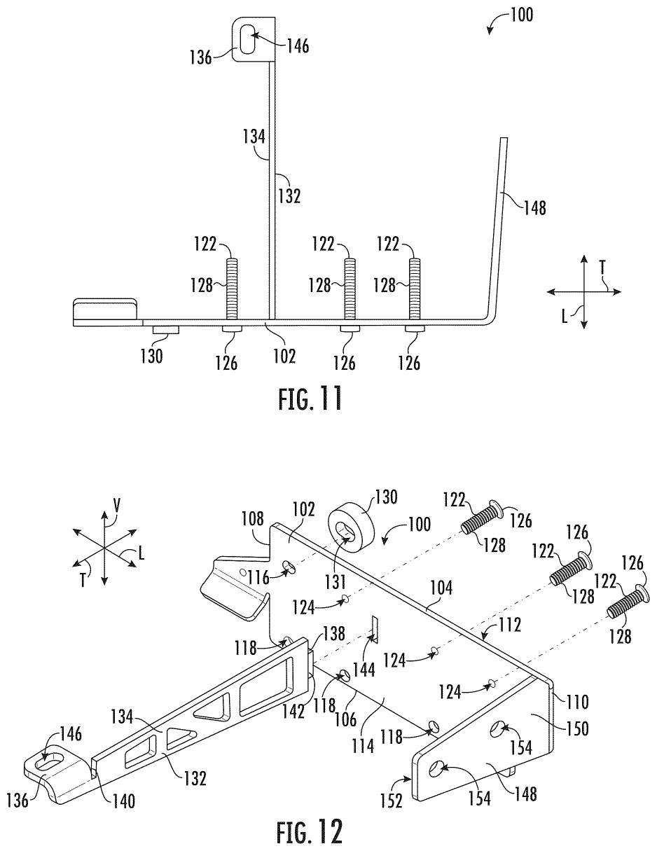

Optionally, the mount bracket 100 may include one or more spacers 130 disposed at the outer face 112 of the main plate 102. The one or more spacers 130 may each be interfaced with the rocker panel 25. In this regard, the one or more spacers 130 may provide a clearance, for instance, along the second direction Y of the vehicle 10, between the outer face 112 of the main plate 102 and the rocker panel 25 for accommodating the heads 126 of the plurality of studs 122 and provide a flat mating surface for the main plate 102. The position of the one or more spacers 130 relative to the main plate 102 may correspond to the location of one or more body holes 116 defined through the main plate 102. For example, as illustrated in FIG. 12, a singular spacer 130 may be disposed at the outer face 112 of the main plate 102 at a location corresponding to a singular body hole 116. In addition, the one or more spacers 130 may each define a slot 131 that is coaxially aligned with the corresponding body hole 116. In this regard, the mechanical fastener may be received through the body hole 116, the slot 131 of the spacer, and the corresponding hole defined through the rocker panel 25 to fasten the main plate 102 to the rocker panel 25.

The mount bracket 100 may include a support member 132 that may be securable to the floorboard 27 of the vehicle 10. For instance, in some embodiments, the mount bracket 100 is secured to (e.g., fastened to) the floorboard 27 of the vehicle 10. In particular, the support member 132 may be fastened to a first crossmember 133 of the floorboard 27 (e.g., FIG. 13). The first crossmember 133 may extend approximately along the first direction X of the vehicle 10. The support member 132 may include an arm 134 and a tab 136. The arm 134 may extend from a proximal end 138 disposed at the inner face 114 of the mount bracket 100 to a distal end 140, for instance, along the transverse direction T. In some embodiments, the arm 134 includes a rib 142 that is inserted into a complimentary slot 144 defined through the main plate 102. Once the rib 142 is inserted into the complimentary slot 144, the arm 134 may be joined (e.g., welded or secured in any other suitable manner) to the main plate 102 at the proximal end 138 of the arm 134. The tab 136 may extend from the distal end 140 of the arm 134, for instance along the lateral direction L. In this regard, the tab 136 may be positioned perpendicular to the arm 134 of the support member 132. The tab 136 may define a mount hole 146 for the receipt of a mechanical fastener 147 (e.g., a bolt, screw, rivet, or the like) therethrough. In some embodiments, the mount hole 146 may define a slot shape for permitting adjustment of the mount bracket 100 (e.g., relative to the body 24) during installation of the mount bracket 100.

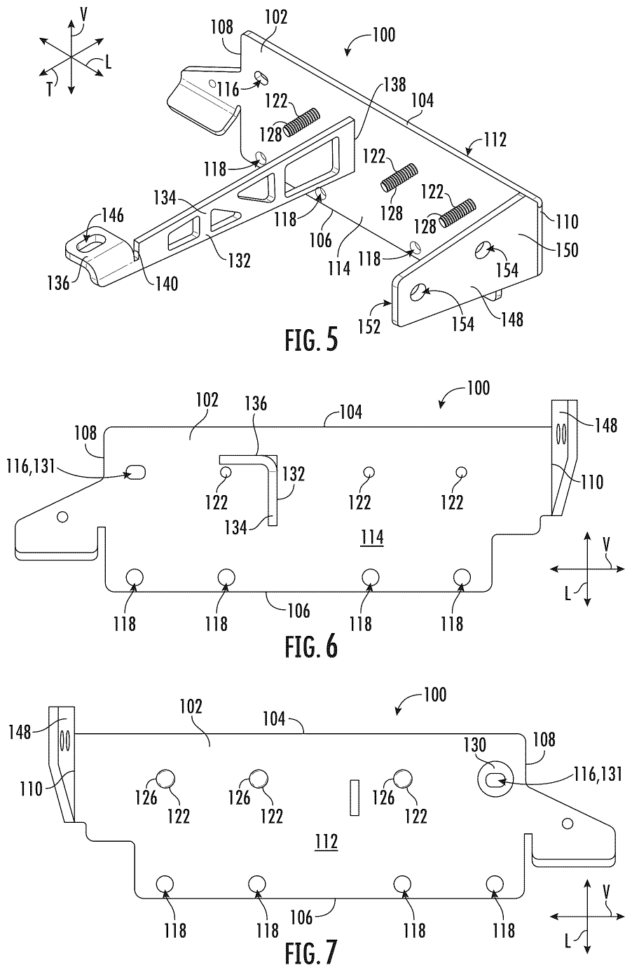

The mount bracket 100 may include a support plate 148 that may be securable to the floorboard 27 of the vehicle 10. For instance, in some embodiments, the support plate 148 is secured to (e.g., fastened to) the floorboard 27 of the vehicle. In particular, the support plate 148 may be fastened to a second crossmember 149 of the floorboard 27 (e.g., FIG. 13). The second crossmember 149 may extend generally along the second direction Y of the vehicle 10. In this regard, the second crossmember 149 may be positioned perpendicular to the first crossmember 133. The support plate 148 may be extended, for instance, approximately along the transverse direction T, from one of the front edge 108 or the rear edge 110. For example, as illustrated in FIGS. 5 through 13, the support plate 148 is extended from the rear edge 110 of the main plate 102 approximately along the transverse direction T. The support plate 148 may include a front face 150 and a rear face 152. The front face 150 and the rear face 152 of the support plate 148 may be spaced apart, for instance, spaced apart along the lateral direction L. The support plate 148 may define one or more mount holes 154 for the receipt of one or more mechanical fasteners 156 (e.g., bolts, screws, rivets, or the like) therethrough.

Now that the construction and configuration of the vehicle 10 and mount bracket 100 have been presented according to one or more exemplary embodiments of the present subject matter, an exemplary method for mounting the running board assembly 38 to the vehicle 10 is provided. For example, referring now to FIG. 14, a method 200 for mounting the running board assembly 38 to the vehicle 10 is provided. It should be appreciated that the exemplary method 200 is discussed herein only to describe exemplary aspects of the present subject matter and is not intended to be limiting to the claimed subject matter.

At 210, the method 200 includes aligning a mount bracket with a body of a vehicle. Initially, a support member of the mount bracket may be aligned with a first crossmember of a floorboard of the body of the vehicle. In particular, a tab of the support member may be aligned to the first crossmember such that a mount hole defined through the tab is aligned with a corresponding hole defined through the first crossmember. In addition, aligning the mount bracket with the body of the vehicle may include temporarily holding the mount bracket in a desired position relative to the body of the vehicle using a mechanical fastener. For example, the mechanical fastener may be disposed through mount hole of the tab and the corresponding hole defined through the first crossmember. The mechanical fastener may be tightened to temporarily support the weight of the mount bracket. As should be appreciated, the mechanical fastener may be tightened in a manner that allows adjustment of the mount bracket relative to the body. For example, the mechanical fastener may be “loosely” tightened such that the weight of the mount bracket is generally supported and adjustment of the mount bracket relative to the body is permitted.

In some embodiments, aligning the mount bracket with the body of the vehicle includes aligning the main plate to a rocker panel of the body. For instance, the main plate may be positioned relative to the rocker panel such that a portion of an outer face of the main plate (or, optionally, an outer face of the one or more spacers) are interfaced with the rocker panel. Additionally, aligning the mount bracket with the body of the vehicle 10 may include aligning a support plate of the mount bracket to the second crossmember. For example, as illustrated in FIG. 13, the support plate 148 may be positioned relative to the second crossmember 149 such that a surface (e.g., the rear face 152) of the support plate 148 is interfaced with the second crossmember 149. In some embodiments, an operator may utilize one or more clamps (e.g., c-clamps, spring clamps, bar clamps, or the like) to temporarily hold the mount bracket 100 in place relative to the body of the vehicle.

Aligning the mount bracket with the body may further include adjusting a position of one or more step holes defined through the main plate relative to the rocker panel. In particular, the mount bracket may be adjusted relative to the rocker panel and the second crossmember such that the each step hole of the or more step holes defines approximately the same distance to a bottom edge of the rocker panel. As such, when a first linkage arm and a second linkage arm of the running board assembly are secured to the mount bracket, a step of the running board assembly may be generally level relative to the body of the vehicle.

In some embodiments, aligning the mount bracket with the body of the vehicle includes drilling pilot holes through the rocker panel and the second crossmember. For instance, when the main plate and the support plate are positioned relative to the rocker panel and the second crossmember, respectively, the location of pilot holes corresponding to the mount holes defined through the main plate and the support plate may be marked, for instance, by a user. To drill the pilot holes, the mount bracket may be removed (e.g., temporarily) from the body of the vehicle and the pilot holes may be drilled at the locations previously marked.

At 220, the method 200 includes securing the mount bracket to the body of the vehicle. Following the mount bracket being aligned to the body, the mount bracket may be secured (e.g., fastened) to the body of the vehicle. For example, mechanical fasteners (e.g., bolts, screws, rivets, or the like,) may be used to secure the main plate, the support member, and the support plate to the rocker panel, the first crossmember 133 and the second crossmember, respectively.

At 230, the method 200 includes securing the running board assembly to the mount bracket. Following the mount bracket being secured to the body of the vehicle, the first linkage arm and the second linkage arm may be hung onto a plurality of studs disposed at an inner face of the main plate. In some embodiments, the first linkage arm is mounted to one or more frontmost studs (e.g., the front two studs 122 as illustrated in FIGS. 5 and 12) and the second linkage arm is mounted to one or more rearmost studs (e.g., the singular rear stud 122 positioned rearward of the support member 132). At 230, securing the running board assembly to the mount bracket may further include installing locking fasteners (e.g., locking nuts) onto the plurality of studs to secure the linkage arms to the plurality of studs. In some embodiments, the locking fasteners are “loosely” secured or tightened relative to the plurality of studs such that additional adjustments can be made.

In addition, securing the running board assembly to the mount bracket may include securing the first linkage arm and the second linkage arm to the main plate using one or more mechanical fasteners (e.g., bolts, screws, rivets, or the like). For example, one or more mechanical fasteners may be extended through one or more step holes and secured to the first linkage arm and/or the second linkage arm. In some embodiments, the mechanical fasteners are “loosely” secured or tightened to the first linkage arm and/or the second linkage arm such that additional adjustments can be made.

Securing the running board assembly may include mounting the step of the running board assembly onto the first linkage arm and the second linkage arm. Mounting the step onto the first linkage arm and the second linkage arm ] may include clipping or fastening the step onto the first linkage arm and the second linkage arm. In some embodiments, a position of the step relative to a side saddle gas tank of the vehicle may be adjusted following mounting the step to the first linkage arm and the second linkage arm. For instance, the step may be moved forward or rearward relative to the first linkage arm and the second linkage arm such that the step may clear (e.g., not engage with) the side saddle gas tank, and more particularly, the bracket or strap of the side saddle gas tank in the retracted position thereof.

At 240, the method 200 includes coupling the running board assembly to a step control module associated with the running board assembly. For instance, a motor of the first linkage arm or the second linkage arm may be connected (e.g., via a wiring harness) to the step control module (e.g., a standalone controller separate from a vehicle control module). The step control module may be mounted at any suitable location within the vehicle. For example, the step control module may be mounted within a front end of the vehicle, such as at an inner fender area of the front end. A wiring harness may be routed from the step control module to the motor. As mentioned above, the step control module may be operably coupled to the door position sensor. In this regard, the step control module may selectively direct the motor to move the running board assembly based on the position of the door.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A vehicle comprising:
a frame;
a body mounted to the frame, the body comprising a rocker panel and a floorboard;
a mount bracket comprising:
a main plate secured to the rocker panel, the main plate extending between a top edge and a bottom edge along a first direction, a front edge and a rear edge along a second direction, and an inner face and an outer face along a third direction,
a support plate secured to the floorboard, the support plate extending from the front edge of the main plate along the third direction, and
a support member secured to the floorboard, the support member extending from the inner face of the main plate along the third direction; and
a running board assembly secured to the mount bracket at the main plate.

2. The vehicle of claim 1, wherein the mount bracket further comprises a plurality of studs extended through the main plate, and
wherein the running board assembly is secured to the mount bracket at the main plate via the plurality of studs.

3. The vehicle of claim 1, wherein the mount bracket further comprises one or more spacers disposed at the outer face of the main plate,
wherein the main plate defines one or more body holes therethrough,
wherein the one or more spacers each define a slot aligned coaxially with a corresponding body hole of the one or more body holes, and
wherein the main plate is secured to the rocker panel via one or more mechanical fasteners disposed within the one or more body holes, the one or more spacers, and one or more corresponding fastener holes defined through the rocker panel.

4. The vehicle of claim 1, wherein the running board assembly comprises a first linkage arm and a second linkage arm,
wherein the main plate defines a plurality of step holes proximate the bottom edge of the main plate,
wherein the first linkage arm and the second linkage arm each define a plurality of mount holes corresponding to the plurality of step holes, and
wherein the running board assembly is secured to the mount bracket at the main plate via one or more mechanical fasteners disposed within the plurality of step holes and the plurality of mount holes corresponding to the plurality of step holes defined by the first linkage arm and the second linkage arm.

5. The vehicle of claim 4, wherein the plurality of step holes are each disposed below the rocker panel.

6. The vehicle of claim 4, wherein the running board assembly further comprises
a motor coupled to at least one of the first linkage arm or the second linkage arm to move the running board assembly between a deployed position and a retracted position.

7. The vehicle of claim 6, further comprising:
a door rotatably mounted to the body;
a door position sensor coupled to the door for determining a position of the door relative to the body; and
a step control module operably coupled to the motor and the door position sensor,
wherein the step control module is configured to direct operation of the motor according to the position of the door relative to the body.

8. The vehicle of claim 1, wherein the support member comprises an arm and a tab,
wherein the arm extends from a proximal end at the inner face of the main plate to a distal end,
wherein the tab extends from the distal end of the arm,
wherein the tab defines a slot therethrough, and
wherein the support member is secured to the floorboard via a mechanical fastener disposed within the slot and a corresponding hole defined through the floorboard.

9. The vehicle of claim 1, wherein the support plate defines one or more mount holes therethrough, and
wherein the support plate is secured to the floorboard via one or more mechanical fasteners disposed within the one or mount holes of the support plate and one or more corresponding holes defined through the floorboard.

10. The vehicle of claim 1, wherein the floorboard comprises a first crossmember and a second crossmember extended perpendicular to the first crossmember,
wherein the support member is secured to the first crossmember, and
wherein the support plate is secured to the second crossmember.

11. The vehicle of claim 1, further comprising:
a side saddle gas tank mounted to an outer rail of the frame,
wherein the side saddle gas tank is disposed between a front axle of the frame and a rear axle of the frame, and
wherein at least a portion of the running board assembly is positioned below the side saddle gas tank.

12. The vehicle of claim 1, wherein the mount bracket is a first mount bracket mounted to a driver side of the body,
wherein the running board assembly is a first running board assembly secured to the first mount bracket, and wherein the vehicle further comprises a second mount bracket mounted to a passenger side of the body and a second running board assembly secured to the second mount bracket.

13. A mount bracket for mounting a running board assembly to a vehicle, the vehicle comprising a frame and a body mounted to the frame, the body comprising a rocker panel and a floorboard, the mount bracket defining a vertical direction, a lateral direction, and a transverse direction, the mount bracket comprising:
a main plate securable to the rocker panel, the main plate extending between a top edge and a bottom edge along the vertical direction, a front edge and a rear edge along the lateral direction, and an inner face and an outer face along the transverse direction;
a support plate securable to the floorboard, the support plate extending from the front edge of the main plate along the transverse direction; and
a support member securable to the floorboard, the support member extending from the inner face of the main plate along the transverse direction,
wherein the running board assembly is securable to the mount bracket at the main plate.

14. The mount bracket of claim 13, further comprising:
a plurality of studs extended through the main plate,
wherein the running board assembly is securable to the mount bracket at the main plate via the plurality of studs.

15. The mount bracket of claim 13, further comprising:
one or more spacers disposed at the outer face of the main plate,
wherein the main plate defines one or more body holes therethrough,
wherein the one or more spacers each define a slot aligned coaxially with a corresponding body hole of the one or more body holes, and
wherein the one or more spacers are each interfaced with the rocker panel.

16. The mount bracket of claim 13, wherein the main plate defines a plurality of step holes proximate the bottom edge of the main plate,
wherein the running board assembly comprises a first linkage arm and a second linkage arm, and
wherein the first linkage arm and the second linkage arm each define a plurality of mount holes corresponding to the plurality of step holes, and
wherein the running board assembly is securable to the main plate via one or more mechanical fasteners disposed within the plurality of step holes and the plurality of mount holes corresponding to the plurality of step holes defined by the first linkage arm and the second linkage arm.

17. The mount bracket of claim 13, wherein the support member comprises an arm and a tab,
wherein the arm extends from a proximal end at the inner face of the main plate to a distal end,
wherein the tab extends from the distal end of the arm,
wherein the tab defines a slot therethrough, and
wherein the support member is securable to the floorboard via a mechanical fastener disposed within the slot and a corresponding hole defined through the floorboard.

18. The mount bracket of claim 13, wherein the support plate defines one or more mount holes therethrough, and
wherein the support plate is securable to the floorboard via one or more mechanical fasteners disposed within the one or mount holes of the support plate and one or more corresponding holes defined through the floorboard.

19. A method for mounting a running board assembly to a vehicle, the method comprising:
aligning a mount bracket with a body of the vehicle;
securing the mount bracket to the body of the vehicle;
securing the running board assembly to the mount bracket; and
coupling the running board assembly to a step control module associated with the running board assembly.

20. The method of claim 19, wherein securing the mount bracket to the body of the vehicle further comprises
securing a main plate of the mount bracket to a rocker panel of the vehicle,
securing a support member of the mount bracket to a first crossmember of a floorboard of the vehicle, and
securing a support plate of the mount bracket to a second crossmember of the floorboard of the vehicle.
